(19) United States
(12) Patent Application Publication
(10) Pub. No.: US 2005/0134746 A1
(43) Pub. Date: Jun. 23, 2005

(54) Controllable video switching method and apparatus

(76) Inventor: Nicholas C. Brandt, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/740,975

(22) Filed: Dec. 18, 2003

(51) Int. Cl. H04N 5/268

(52) U.S. Cl. 348/705; 348/706; 710/8

(57) ABSTRACT

In one embodiment, the invention includes a plurality of video inputs, a video output, a power supply, a switch matrix between the video inputs and the video output, and a controller powered by the power supply to control the switch matrix to alternately connect one of the video inputs to the video output.

### BACKGROUND

The present invention relates to the field of switching video sources between inputs and outputs, and in particular to a programmable video switcher capable of external control.

Video sources continue to increase in variety and fall in price. Digital video cameras are available at previously unknown price points and form factors. In addition, recorded video entertainment is available from a larger variety of different storage media and broadcast sources. On the other hand, displays remain large and expensive by comparison. Accordingly, surveillance equipment, households and conference centers use video switches to couple several video sources to a single display.

Currently available video switches have several video input connectors and usually one or two video output connectors. Some devices include audio connectors, which can be switched together with the video. One common type of switch has a manually activated mechanical or soft switch with which a user can select one of the inputs for connection to an output. The manual operation is simple but requires that the user be always within reach of the switch. In addition it does not allow for automatic cycling between, for example, different surveillance cameras.

Another type of switch has an interface to a computer running a specialized software suite. The software switches the connectors based on a system clock and a variety of different interrupts. While such a system allows for a great variety of sophisticated and automated functions, it is much more expensive and less reliable than a manually operated switch.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1A is a diagram of a rear connection panel of a video switching system with video input and output connectors according to an embodiment of the present invention;

FIG. 1B is a diagram of a front control panel of the video switching system of FIG. 1A;

FIG. 2 is a block diagram of the video switching system according to an embodiment of the invention;

FIG. 3 is a flow diagram of a run time program according to an embodiment of the invention;

FIG. 4 is a flow diagram of a setup program according to an embodiment of the invention;

FIG. 5 is a diagram of an on screen display for a setup menu according to an embodiment of the invention; and

FIG. 6 is a diagram of an on screen display for setting system parameters according to an embodiment of the invention.

### DETAILED DESCRIPTION

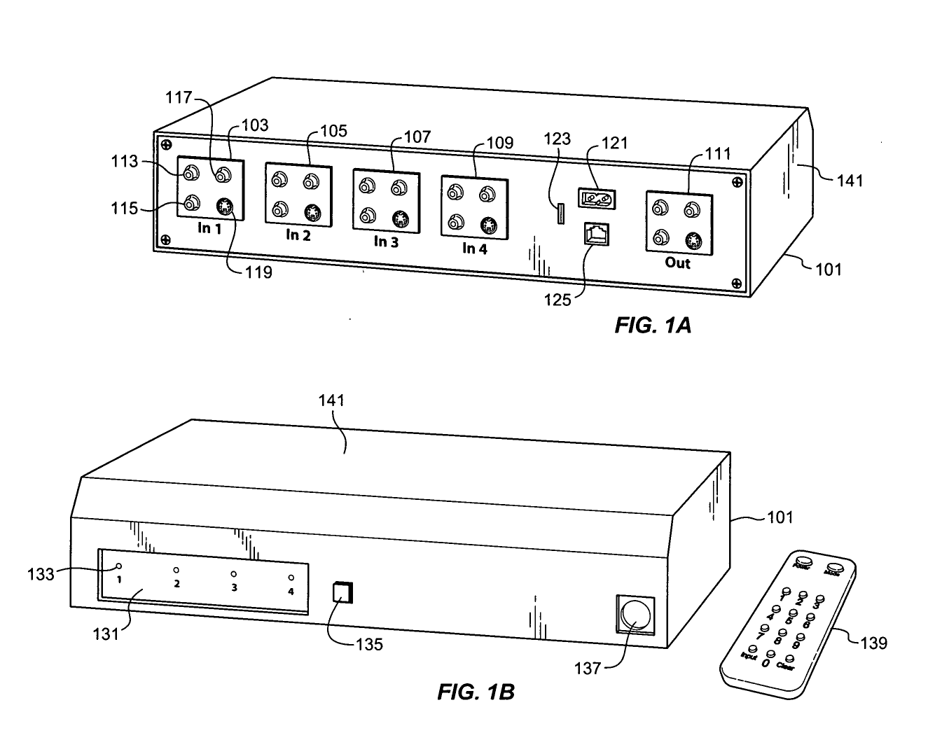

Referring to FIG. 1A, a video switching system 101 has a rear connection panel with connectors for sending and receiving video signals. In the illustrated embodiment, there are four input connector sets, 103, 105, 107, 109 and one output connector set 111, however, the particular number of inputs and outputs will depend on the particular application. Each connector set has a coaxial cinch (RCA) connector for right audio 113, for left audio 115 and for composite video 117. Each connector also has an S-Video (Hosiden) connector 119.

There are a great variety of wired audio and video connectors currently available with more being developed. While analog connectors are shown, digital connections can be added or substituted for those illustrated. Other types of connectors that can be used in addition to or instead of those shown include F-type coaxial RF (Radio Frequency) connectors, component video, DIN (Deutsche Industrie Norm) connectors, DVI (digital video interface), HDMI (High Definition Multimedia Interface), VGA (Video Graphics Adapter), S/PDIF (Sony/Philips Digital Interface), Toslink, i.Link, USB (Universal Serial Bus) and IEEE 1394 (Institute of Electrical and Electronics Engineers) or Firewire. There are also several different proprietary connectors which may be preferred for particular applications. The types of connectors may be modified to suit a particular application or as different connectors become adopted.

Alternatively, the illustrated connectors can be wireless connectors. One or more tuners can receive wireless video with or without audio using any one of a variety of different standards. This video can then be transmitted with a wired or wireless connection to a display. Digital video cameras are currently available with many different types of wireless transmitters. Open standards transmitters include Bluetooth, and IEEE (Institute of Electrical and Electronic Engineers) 802.11 a, b and g, however, there are many proprietary transmission standards used, for example, in security and surveillance cameras.

There are many different possible devices that can be coupled to the switching system using the connectors described above. In the example of FIG. 1A, these include still and video cameras, broadcast television receivers from radio, cable, or satellite signals, video players, such as a tape, disk, and memory players, audio players, such as tape, disk and memory players, computers with media player hardware and software and other digital devices.

These inputs, when switched to the outputs may be rendered on a monitor, or projector, or any other kind of perceivable video display. The audio portion may be routed through an amplifier, such as an AN receiver or a sound processing engine, to headphones, speakers or any other type of sound generation device. The outputs may also be sent to an external recorder, such as a VTR, PVR, CD or DVD recorder, memory card etc.

The switching system also includes a power supply mains input 121, a bus connector 123, for example a USB or Firewire connector, and a network connector 125, such as an RJ11, or RJ45 (Registered Jack) connector. These connectors allow the switching system to be controlled by remote devices. Other types of connectors can be used as well, for example, there are many remote controllers that use RS-232 (Recommended Standard) connectors.

FIG. 1B shows an example of a front panel for the switching system of FIG. 1A. This front panel has a display 131, and a keyboarded 135. In the illustrated example, the display has a single LED (Light Emitting Diode) for each rear panel video input. In one mode, whenever a rear input connector is coupled to the output connectors, the corresponding LED is illuminated. Additional LEDs can be added to indicate power status, mode and any other system parameters. Alternatively, a more complex alphanumeric or graphic display can be used. As a further alternative, instead of, or in addition to the display, any information or messages to be displayed can be provided at the rear panel video output 111, to be seen on the connected display. The information or messages can be substituted for a video input, if any, or superimposed over the video provided on the video output connector.

The keyboard 135, in the present example, has a single button for simplicity. The button can be assigned different functions depending on the system operating mode. In one embodiment, the button can be used to switch from one video input to another in one mode. In another mode in which the switcher cycles through the inputs, the button can be used to pause the cycle and hold the video output at a particular input. Additional buttons can be used to provide more functions or to make the system simpler to use. Alternatively, the system can be operated without a control panel. Settings can be provided through a device connected to a rear panel input or using a remote control.

The embodiment of FIG. 1B includes a lens 137 to protect an infrared (IR) receiver. This allows an infrared remote control 139 to send commands to the device. Alternatively, using an infrared transceiver, two-way communication with the system can be established. In some applications, RF communications can be used instead of infrared communications. With an RF remote control, the transceiver would be a radio transceiver and no infrared lens 137 would be required. The antenna may be hidden inside the housing of the system.

The example of FIG. 1B shows a simple user interface that can be used to configure and control the video switching system. All of the configuration and operation settings described below can be accomplished using the LEDs and the button. The remote control can be used in addition to or instead of the LEDs and the button. Alternatively, the switching system can be provided with no front panel controls or displays. Configuration and use can be controlled through a device coupled to one of the rear panel connectors either locally or remotely. For example a diagnostic and control terminal can be connected to a rear panel USB port 123, or a remote client can communicate over a network connection 125.

The video switching system is shown as a self-contained unit with its own power input connector 121 and housing 141. The power input connector may be coupled to a power supply inside the housing that powers all of the subcomponents of the switching system. The nature of the power connector and the housing can vary depending on the particular application for the device. If the video input connectors are USB or Firewire connectors, for example, the switching system may draw power from the connected USB devices instead of, or in addition to the power input connector. Different size and form factors may be desired to coordinate with other equipment. The switching system can be rack mounted, used like a set-top box beside, above, or below a display or used as a component in an entertainment system.

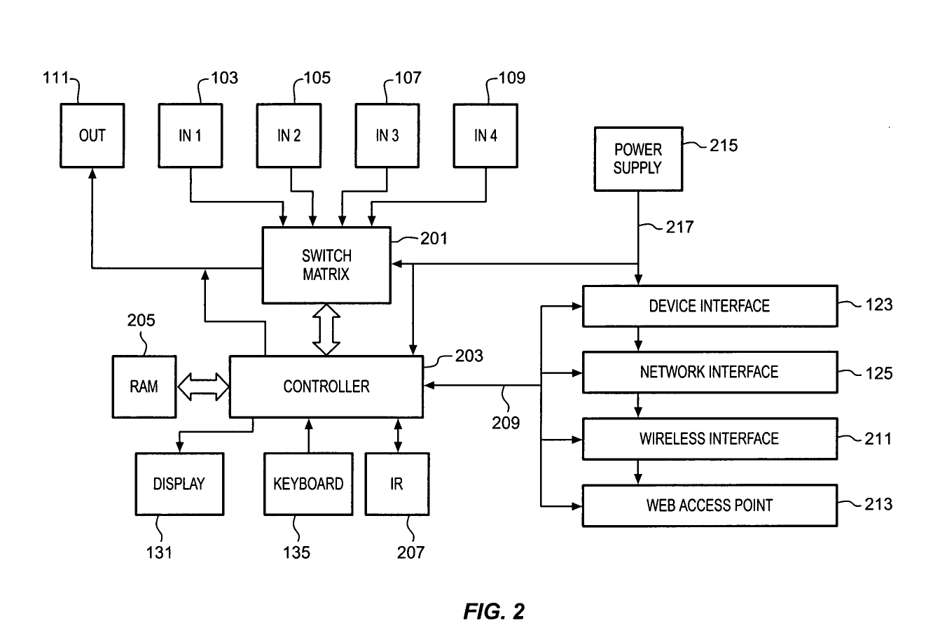

FIG. 2 shows an example of a possible internal hardware configuration for the video switching system of FIGS. 1A and 1B. In FIG. 2, each of the video input connectors 103, 105, 107, 109 are connected to a switch matrix 201. The video output connector 111 is also connected to the switch matrix. As with FIG. 1A, the particular number of input and output connectors will depend upon the particular embodiment.

The switch matrix is coupled to a controller which controls the switching operations of the switch matrix. The controller and the switch matrix may be implemented as a single integrated circuit or as two discrete components as shown. The controller also controls all of the other functions of the video switching system. The controller may be implemented using any of a variety of different processors, ASICs (Application Specific Integrated Circuit) or microcontrollers. Some examples include the Intel® 808x line of processors, such as the 8082, 8083 or 8086 microprocessors. Note that the invention is not limited to the particular choice of processor suggested herein.

The controller can drive all functions of the system or other processors can be used for particular subsystems. For example, the controller 203 is coupled to a display 131. For the LED display of FIG. 1B and other simple displays, the controller can be coupled directly to the display. For more complex graphic displays, a display controller can be added.

The controller can be coupled to a RAM 205 (Random Access Memory) to store instructions, settings and display images. Alternatively, the internal memory of the controller can be used. The controller is also coupled to the display 131, the keyboard 135 and an infrared or RF interface 207, mentioned above. The display, keyboard and IR interface provide access to setting and configurations of the controller.

FIG. 2 also shows several different possible additional interfaces to external devices. The video switching system can have any one or more of these or none, depending on the application. Each interface is shown as being connected to a common bus 209, however, any one or more of these devices can be connected directly to the controller or through an intermediate processor or device. The interfaces include the device interface 123 for USB, Firewire and similar connections. The network interface 125 for LAN (local area network), Ethernet, Internet or dial-up connections, a wireless interface 211, for a wireless remote control or to support WAN and LAN connections using Bluetooth IEEE 802.11 or any other protocol, and a web access point 213. The web access point can include its own processor to support Internet protocol communications that allow the video switching device to act like a web server or client. This can allow video to be transmitted to and received from other IP (Internet Protocol) addresses. If a remote communications bus 209 is provided, then the display, keyboard and IR interface can be coupled to this bus instead of the direct connections shown in FIG. 2.

FIG. 2 also shows a power supply 215 coupled to the mains input connector 121 (shown in FIG. 1A). The power supply provides an appropriate independent source of power for the controller, switch matrix and device interfaces using specific power lines 217. Any other devices requiring power, such as the RAM and display may also be powered by appropriate supply lines (not shown). The power supply can draw energy from the mains, batteries, a powered bus, such as USB, or many other sources.

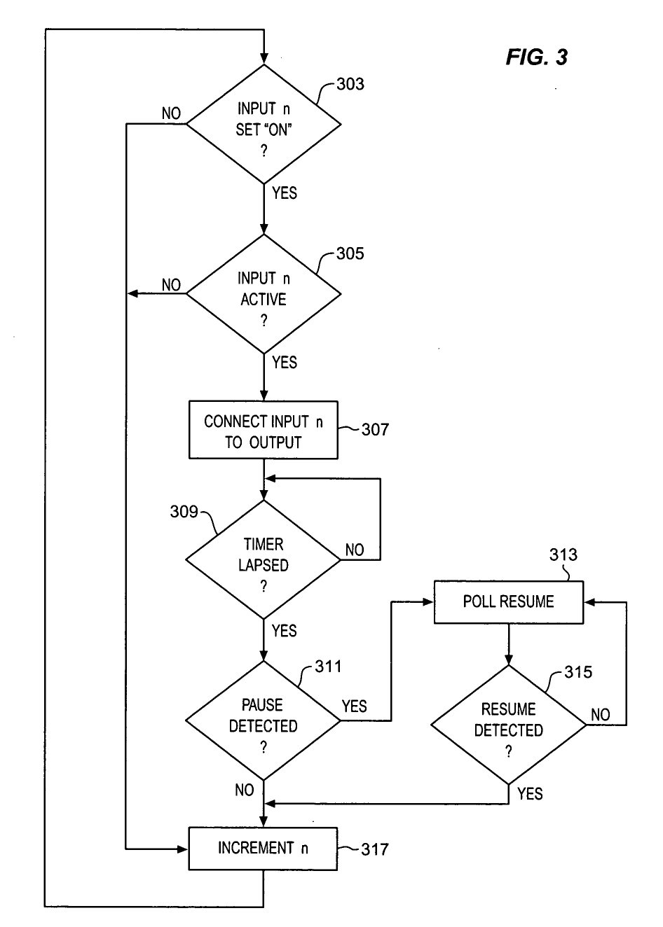

FIG. 3 is a flow diagram showing an example of a run-time program that can be executed by the controller in accordance with an embodiment of the invention. In FIG. 3, the video switcher is set to connect each active video source to the output for a preset or selected amount of time. However, change from one video source to another can be interrupted at any time. The process begins with one of the video sources. This source can be tagged with an identifier “n”. The particular video source to start with can be selected as input 1, the last input that was connected, or to any other input. In one example, the video switcher then tests input n to determine if the input is set to “ON” in block 303. If n starts as n=1, then the system tests input 1. ON refers to an internal setting. A user can set the switching system to pass over certain inputs (set to OFF), if desired. If the input is not set to ON then the system goes to block 317 and increments n. In other words n is set to n+1. If n was n=1, then n is set to n=1+1=2. The system goes to input 2.

If the input is set to “ON” then, at block 305, the input is tested to determine whether there is an active video signal present. If there is no active video signal, then the switcher increments n at block 317 in order to go to the next input connection. The switching system can also be configured to send no video to the output for the preset time if the input is set to ON but there is no signal at the input.

An active video signal can be detected in a variety of different ways. In one embodiment, a voltage level detector is applied to one or more of the input lines. If the level is below a threshold then it is determined to be absent. For a digital connector, a pulse or edge detector may be used. Any other active signal detector may be used instead.

If the input is set to ON and there is a signal, then the controller, at block 307, commands the switch matrix to connect the tested input connector to the output connector. The user will now see, for example, input 1, displayed on the video monitor. At the same time, the controller can adjust the front panel display, if present. In the embodiment of FIG. 1B, the appropriate front panel LED will be activated. At block 309, the system will check a timer. After the timer has elapsed, at block 311 it will check to determine whether the user has sent a pause command. If there is no pause command, then the system will increment n at block 317 to go to the next input and then return to block 303 to test the next input.

A pause command can be sent by a user in many different ways. The user can push the button on the keyboard 135 or a remote control 139. The user can also send a remote command through a device or network interface. If a pause command has been detected, the system can either reset the timer or wait for a resume command. In the example of FIG. 3, the system polls for a resume command at block 313. If one is detected, at block 315, then it increments n at block 317. If no resume command is detected, then it continues to poll for a resume command until one is detected. The continued polling can be limited by a timer if desired. A resume command can be sent in any of the ways that a pause command is sent. For the single button keyboard of FIG. 1B, if the user wants to stop the system from cycling through the input, the button is pushed. To resume the cycling the button is pushed again.

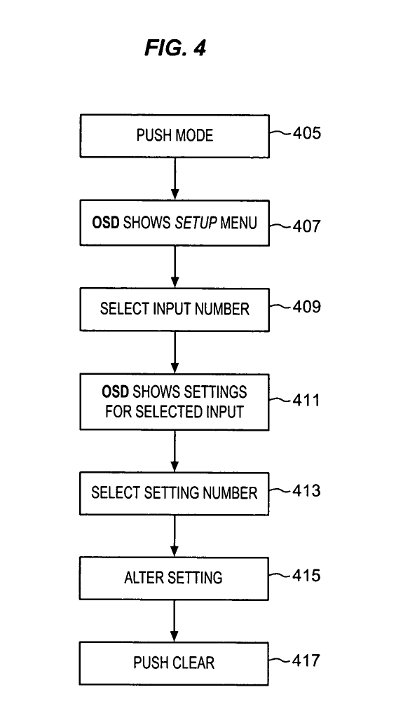

In FIG. 4, the settings of the video switching system can be modified. There are many different ways to modify the settings and the illustration of FIG. 4 is provided as one example. For purposes of FIG. 4, the video switching system generates menus and provides them to the video output connector. These choices will then appear on a connected display. As an alternative, a two-way IR or RF interface with a display can be used or a device connected to any of the other interfaces. A web access point can be used to allow the settings to be modified from a remotely located computer.

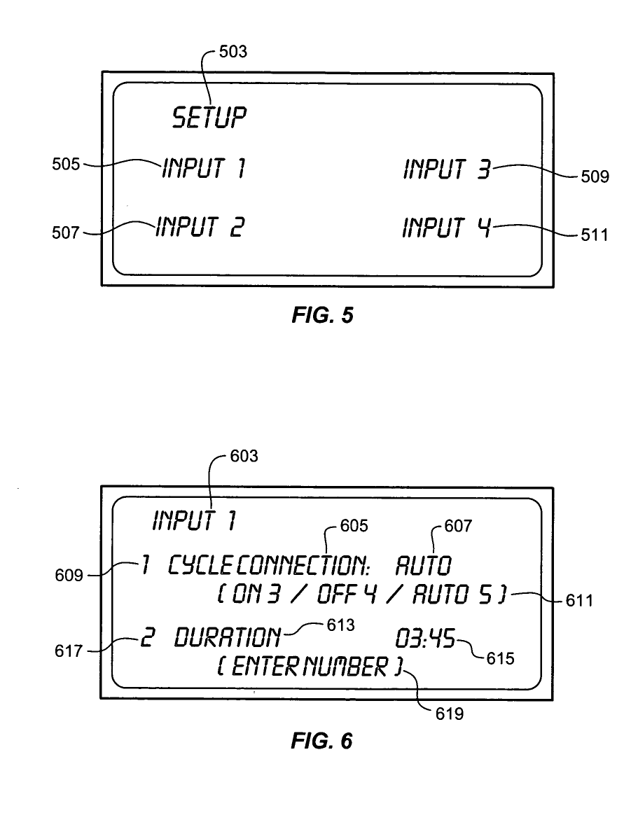

The process of FIG. 4, begins at block 405 as the user pushes a MODE button or a SETUP button on the remote control. Alternatively, the user can push the keyboard button 135 for a longer period, e.g. at least three seconds to select modes. At block 407, the MODE button causes the controller to generate an OSD (On Screen Display) that shows a SETUP menu. An example of one such display is provided in FIG. 5. The SETUP menu has a title 503, SETUP, and a list of all the inputs 505, 507, 509, 511. In this case, there are four inputs labeled 1-4, however the number of inputs and the labels can be altered as appropriate. The OSD can also show a total cycle time to run through all of the inputs and any other system parameters or settings, including which video connectors are receiving active video or audio.

The user then selects an input number from 1 to 4 in block 409. This can be by pushing a number on the remote or by repeatedly pushing the front panel button to cycle through the inputs. On receiving a selection, the OSD shows the current settings for the selected input at block 411. In the current example, there are only two settings as shown in FIG. 6. However, any number of other settings can be added. For example, some inputs can be set to connect only audio or only video. Timer functions can be added or removed from different parts of a cycle. Additional functions such as sending stills to an IP address or other remote or network location can be added to different ones of the inputs. The order and frequency of each input's connection can also be set.

As shown in FIG. 6, the Input OSD, also has a title 603, Input 1, and a set of options. The first option 605 is Cycle Connection and it includes a display of the current value 607 and a selection key 609. By pushing 1 on the remote or scrolling with the keyboard button, the user can select to change the Cycle Connection parameters. The first option also provides numerical indexes 611 to change the setting. The OSD also provides a second option 613, Duration, and displays the current value 615 as well as a selection key 617. Any number of additional options can be provided in the same way.

To change any of the set parameters, the user selects a setting number at block 413, and alters the setting at block 415. For duration, the user pushes 2 on the remote and then enters a new number for the duration. Using the single button control panel, the user can scroll to the duration option by pushing the button twice, then select a number by repeated pressing of the button or by holding the button until the number has run up to the desired number. When finished, the user can push CLEAR on the remote at block 417. The particular buttons to be provided on the remote and the number and types of entries used for changing any of the settings above can be adapted to suit any particular application or design choice. As an example, for some applications, arrow buttons may be preferred over numerical buttons or a combination can be used. The OSD of FIG. 6 may also be divided into several levels, so that only the two options are displayed. After the selection of an option, then the setting for the selection of an option can be allowed. The OSDs shown in FIGS. 5 and 6 are intended only as illustrations.

For option 1 in FIG. 6, cycle connection, the three choices listed as examples are ON, OFF, and AUTO. These can be selected to mean many different things and some examples are provided with reference to FIG. 3. In one example, ON means that the active video detection features are ignored or disabled. The system will switch to the input whether there it has active video or not. OFF can be set to mean that the system will never switch to the input, until the setting is altered. This is useful when there is a camera or other source connected to the connector but the signal on that connector is not of interest. ON and OFF can also be used if the system does not have an automatic feature. The AUTO setting will allow a connection to the input only if active video is detected on the connector. This eliminates the need to alter the settings when video sources are added or removed from the rear panel connectors.

It is to be appreciated that a lesser or more equipped video switching system, microcontroller and connection array than the examples described above may be preferred for certain implementations. Therefore, the configuration of the video switching system and its components will vary from implementation to implementation depending upon numerous factors, such as price constraints, performance requirements, technological improvements, or other circumstances. Embodiments of the invention may also be applied to other types of systems that use different hardware architectures than that shown in FIGS. 1A, 1B and 2.

In the description above, for purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various steps. The steps of the present invention may be performed by hardware components, such as those shown in FIGS. 1A, 1B and 2, or may be embodied in machine-executable instructions, which may be used to cause general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program a media center (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods and apparatus are described in their most basic form but steps may be added to or deleted from any of the methods and components may be added or subtracted from any of the described apparatus without departing from the basic scope of the present invention. It will be apparent to those skilled in the art that many further modifications and adaptations may be made. The particular embodiments are not provided to limit the invention but to illustrate it. The scope of the present invention is not to be determined by the specific examples provided above but only by the claims below.

1. An apparatus comprising:
a plurality of video inputs;
a video output;
a power supply;
a switch matrix between the video inputs and the video output; and
a controller powered by the power supply to control the switch matrix to alternately connect one of the video inputs to the video output.

2. The apparatus of claim 1, further comprising a user interface coupled to the controller to receive switching commands from a user and send them to the controller.

3. The apparatus of claim 2, wherein the user interface comprises a switch.

4. The apparatus of claim 2, wherein the user interface comprises an infrared receiver.

5. The apparatus of claim 2, wherein the user interface comprises a bus interface to receive commands from a remote device coupled to the bus.

6. The apparatus of claim 1, further comprising a network interface coupled to the controller to receive switching commands from a remote network device.

7. The apparatus of claim 6, wherein the network interface comprises an Internet access point.

8. The apparatus of claim 6, wherein the network interface further comprises a video interface to transmit video from the switch matrix to a remote network device.

9. The apparatus of claim 1, further comprising a graphics module coupled to the video output to generate menu display signals and provide them to the video output.

10. The apparatus of claim 9, wherein the menu displays present a menu of the video inputs and a menu of cycle time for display of each video input.

11. The apparatus of claim 1, further comprising an external housing containing the power supply, switch matrix and controller and to which the video inputs and video output are connected.

12. An apparatus comprising:
a plurality of video inputs;
a video output;
a keyboard to receive a video input selection from a user; and
a controller to receive the video input selection and to couple the selected video input to the video output.

13. The apparatus of claim 12, further comprising a bus coupled to the processor and wherein the keyboard comprises a remote device coupled to the bus.

14. The apparatus of claim 12, wherein the remote device comprises a network interface to receive switching commands from a remote network device.

15. The apparatus of claim 12, further comprising a graphics module coupled to the video output to generate menu display signals and provide them to the video output.

16. The apparatus of claim 12, further comprising a display coupled to the controller and wherein the controller generates graphics to present on the display.

17. The apparatus of claim 16, wherein the controller generates graphics to indicate which of the video inputs is coupled to the video output.

18. The apparatus of claim 1, further comprising an external housing containing the keyboard and controller and to which the video inputs and video output are connected.

19. A method comprising:
coupling a first video input to a video output;
polling to determine whether an interrupt is received;
if no interrupt is received, then coupling a second video input to the video output;
polling to determine whether an interrupt is received after coupling the second video input; and
if no interrupt is received after coupling the second video input, then coupling a third video input to the video output.

20. The method of claim 19, further comprising detecting whether an active video signal is present at the first video input and if no active video signal is detected, then coupling the second video input to the video output.

21. The method of claim 19, further comprising waiting for a predetermined period of time after coupling the first video input and before coupling the second video input.

22. The method of claim 19, further comprising, if an interrupt is received after coupling the first video signal, then not coupling the second video signal until after a second interrupt is received.

23. The method of claim 19, further comprising polling to determine whether an interrupt is received after coupling the third video input, then coupling the first video input to the video output.

24. A machine-readable medium having instructions thereon which, when executed by a machine cause the machine to perform operations comprising:
coupling a first video input to a video output;
polling to determine whether an interrupt is received;
if no interrupt is received, then coupling a second video input to the video output;
polling to determine whether an interrupt is received after coupling the second video input; and
if no interrupt is received after coupling the second video input, then coupling a third video input to the video output.

25. The medium of claim 24, further comprising instructions for detecting whether an active video signal is present at the first video input and if no active video signal is detected, then coupling the second video input to the video output.

26. The medium of claim 24, further comprising instructions for waiting for a predetermined period of time after coupling the first video input and before coupling the second video input.

27. The medium of claim 24, further comprising instructions for, if an interrupt is received after coupling the first video signal, then not coupling the second video signal until after a second interrupt is received.

28. The medium of claim 24, further comprising instructions for polling to determine whether an interrupt is received after coupling the third video input, then coupling the first video input to the video output.
